(19) United States
(12) Patent Application Publication
(10) Pub. No.: US 2013/0186244 A1
(43) Pub. Date: Jul. 25, 2013

(54) Chuck

(71) Applicant: Jack Lin, Taichung City (TW)

(72) Inventor: Jack Lin, Taichung City (TW)

(21) Appl. No.: 13/353,543

(22) Filed: Jan. 19, 2012

(51) Int. Cl. B23B 31/107; B25G 1/00

(52) U.S. Cl. 81/491; 279/46.7

(57) ABSTRACT

Disclosed is a chuck including a body, at least one ball and a helical spring. The body includes an axial space defined therein and at least one radial bore with a small open end near the axial space and a large open end in an external side thereof. The ball includes a first section movably placed in the radial bore, a second section movable into the axial space, and a third section movably placed outside the radial bore. The helical spring is placed around the body and in contact with the third section of the ball for biasing the second section of the ball into a recess defined in a bit inserted in the axial space.

### BACKGROUND OF INVENTION

1. Field of Invention

The present invention relates to a tool and, more particularly, to a chuck for connecting a bit to a handle of a tool.

2. Related Prior Art

As disclosed in U.S. Pat. No. 5,309,798, German Patent 20201012 and Taiwanese Patent M391448, a first type of chucks includes a body, a ball and a leaf spring. An end of the body is fit in an end of a handle. Another end of the body includes an axial space defined therein, an annular groove defined in an external side, and a radial bore via which the axial space is in communication with the annular groove. A bit includes a first end for insertion in the axial space and a second end for driving a screw for example. The bit further includes an annular groove defined in an external side. The leaf spring is a C-shaped element with a slit defined therein and a bore defined therein opposite to the slit. The ball includes a first section placed in the radial bore of the body before the leaf spring is placed in the annular groove of the body, a second section for insertion in the annular groove of the bit placed in the space, and a third section placed in the bore of the leaf spring. Thus, the bit is connected to the body via the balls, which are biased by the leaf spring. The leaf spring is however vulnerable to permanent deformation and loss of elasticity so that it fails to bias the ball against the bit.

As disclosed in U.S. Pat. Nos. 5,791,212, 6,082,233 and 6,520,509 and Taiwanese Patent No. 551253, a second type of chucks includes a C-clip instead of the leaf spring of the first type of chucks. Like the leaf spring, the C-clip is vulnerable to permanent deformation and loss of elasticity so that it fails to bias the ball against the bit.

A third type of chucks is disclosed in U.S. Pat. No. 6,848,346 and German Patent No. 10222230. The third type of chucks includes an elastic ring instead of the leaf spring of the first type of chucks and the C-clip of the second type of chucks. Like the leaf spring and the C-clip, the elastic ring is vulnerable to permanent deformation and loss of elasticity so that it fails to bias the ball against the bit.

The present invention is therefore intended to obviate or at least alleviate the problems encountered in prior art.

### SUMMARY OF INVENTION

It is the primary objective of the present invention to provide a reliable chuck for connecting a bit to a handle of a tool.

To achieve the foregoing objectives, the chuck includes a body, at least one ball and a helical spring. The body includes an axial space defined therein and at least one radial bore with a small open end near the axial space and a large open end in an external side thereof. The ball includes a first section movably placed in the radial bore, a second section movable into the axial space, and a third section movably placed outside the radial bore. The helical spring is placed around the body and in contact with the third section of the ball for biasing the second section of the ball into a recess defined in a bit inserted in the axial space.

Other objectives, advantages and features of the present invention will be apparent from the following description referring to the attached drawings.

### BRIEF DESCRIPTION OF DRAWINGS

The present invention will be described via detailed illustration of nine embodiments referring to the drawings wherein:

FIG. 1 is a cross-sectional view of a chuck according to the first embodiment of the present invention;

FIG. 2 is a front view of the chuck shown in FIG. 1;

FIG. 3 is a rear view of the chuck shown in FIG. 1;

FIG. 4 is a cross-sectional view of the chuck taken along a line A-A shown in FIG. 1;

FIG. 5 is a cross-sectional view of a handle equipped with the chuck shown in FIG. 1;

FIG. 6 is a side view of a bit partially inserted in the chuck shown in FIG. 5;

FIG. 7 is an enlarged, partial view of the bit shown in FIG. 6;

FIG. 8 is a side view of the bit in another position than shown in FIG. 7;

FIG. 9 is a side view of various bits that can be connected to the chuck shown in FIG. 1;

FIG. 10 is a cross-sectional view of a chuck according to the second embodiment of the present invention;

FIG. 11 is a front view of the chuck shown in FIG. 10;

FIG. 12 is a rear view of the chuck shown in FIG. 10;

FIG. 13 is a cross-sectional view of a handle equipped with the chuck shown in FIG. 10;

FIG. 14 is a cross-sectional view of another handle equipped with two chucks as shown in FIG. 10;

FIG. 15 is a cross-sectional view of another handle equipped with a chuck as shown in FIG. 10 and a chuck according to the third embodiment of the present invention;

FIG. 16 is a cross-sectional view of a chuck according to the fourth embodiment of the present invention;

FIG. 17 is a front view of the chuck shown in FIG. 16;

FIG. 18 is a cross-sectional view of a chuck according to the fifth embodiment of the present invention;

FIG. 19 is a front view of the chuck shown in FIG. 18;

FIG. 20 is a perspective view of a body of a chuck according to the sixth embodiment of the present invention;

FIG. 21 is a perspective view of a body of a chuck according to the seventh embodiment of the present invention;

FIG. 22 is a perspective view of a body of a chuck according to the eighth embodiment of the present invention; and

FIG. 23 is a cross-sectional view of a chuck according to the ninth embodiment of the present invention.

### DETAILED DESCRIPTION OF EMBODIMENTS

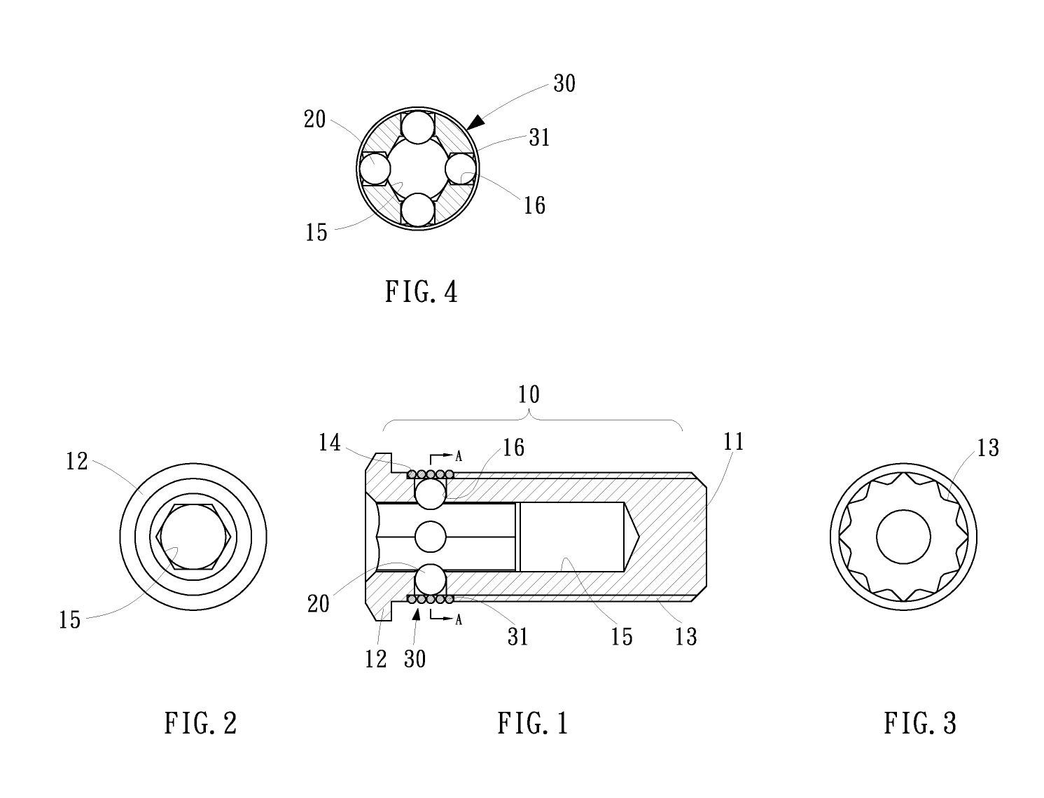

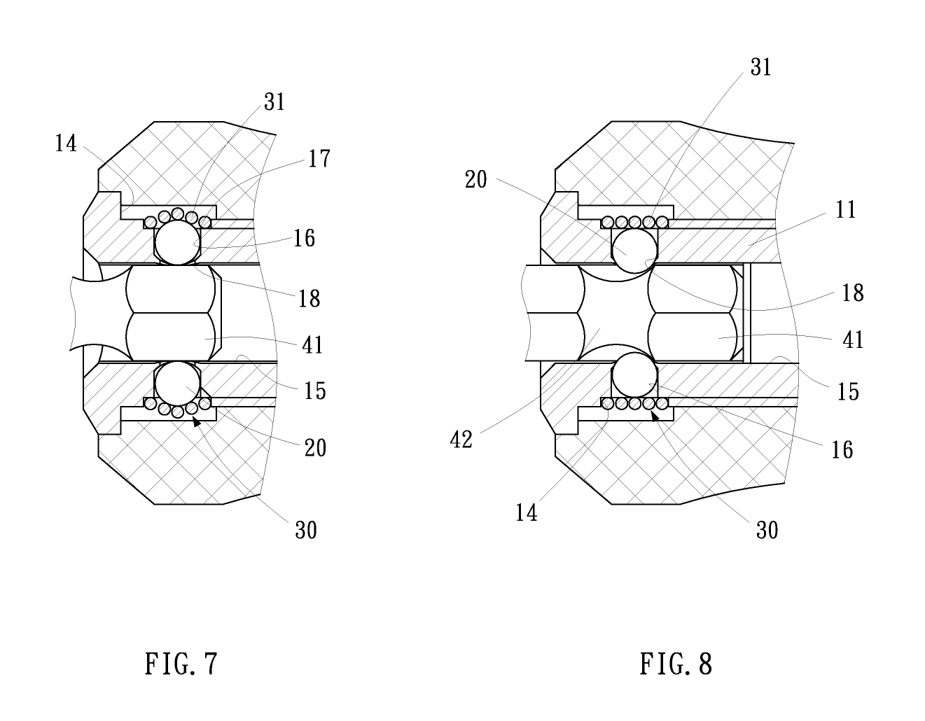

Referring to FIGS. 1 to 4, there is shown a chuck 10 according to a first embodiment of the present invention. The chuck includes a body 11, four balls 20 and a helical spring 30. The body 11 includes an annular flange 12 formed thereon, a ribbed section 13 formed next to the annular flange 12, an annular groove 14 defined in the ribbed section 13, an axial space 15 defined therein, and four radial bores 16 defined therein. The axial space 15 is a hexagonal space. The radial bores 16 are evenly placed around the body 10. Referring to FIG. 7, each of the radial bores 16 includes a large open end 17 in communication with the annular groove 14 and a small open end 18 in communication with the axial space 15.

Each of the balls 20 includes a first section placed in a respective one of the radial bores 16, a second section movable into the axial space 15, and a third section in contact with the helical spring 30 in the annular groove 14.

The helical spring 30 includes several sections 31 each extending for 360° about an axis. The helical spring 30 is placed in the annular groove 14. The balls 20 are biased by the helical spring 30.

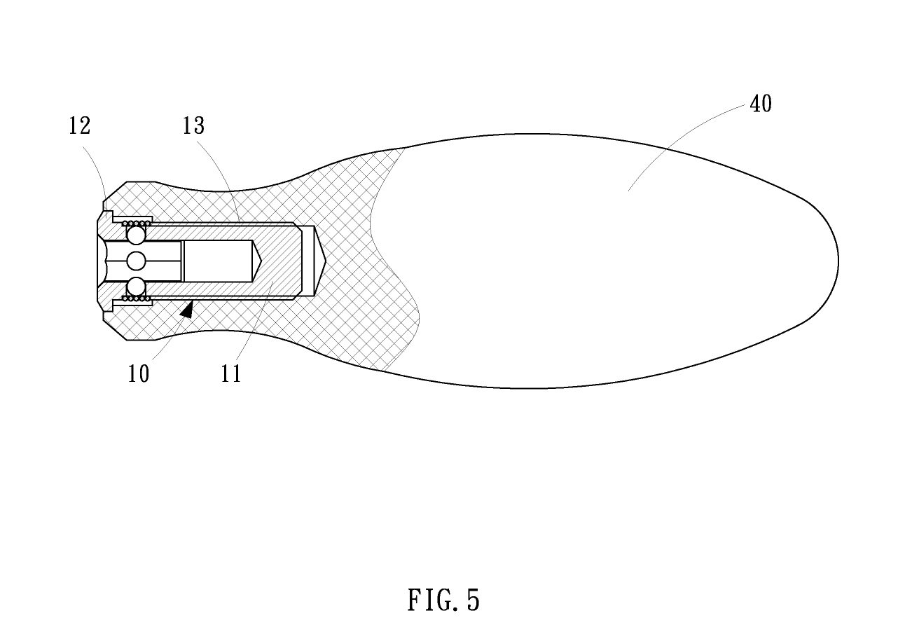

Referring to FIG. 5, the annular flange 12 is abutted against an end of a handle 40 while the ribbed section 13 of the body 11 is fit in the handle 40. Thus, the body 11 cannot be moved and rotated relative to the handle 40.

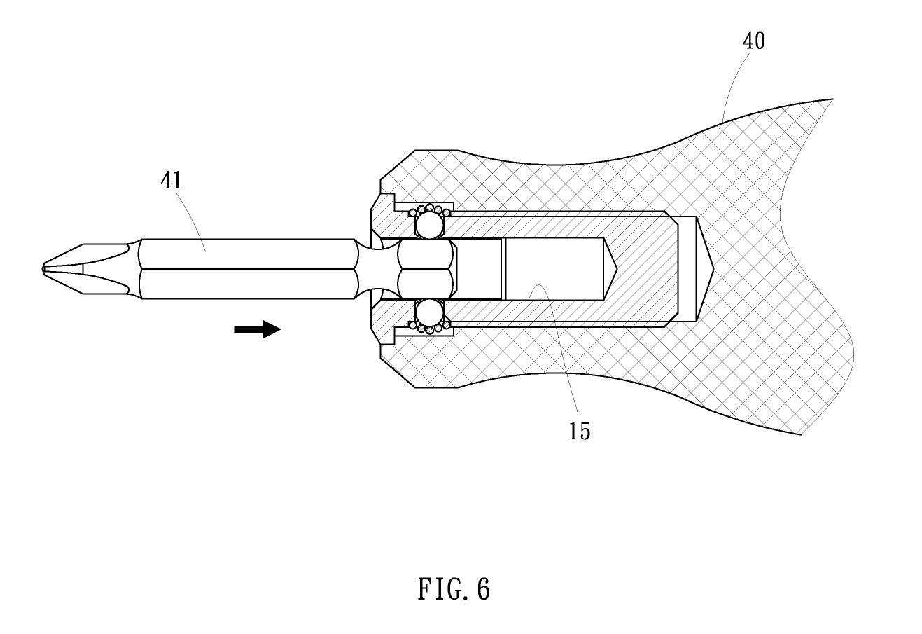

Referring to FIG. 6, a bit 41 includes a first end for insertion in the axial space 15 and a second end for driving a screw for example. The bit 41 further includes an annular groove 42 defined in an external side.

Referring to FIG. 7, the bit 41 is inserted in the axial space 15. The second section of each of the balls 20 is in contact with the bit 41 so that the second section of each of the balls 20 is placed outside the axial space 15. The third section of each of the balls 20 is in contact with some of the sections 31 of the helical spring 30 placed in the annular groove 14. Thus, the balls 20 are biased by the helical spring 30. The external diameters of the sections 31 of the helical spring 30 in contact with the balls 20 increase while the external diameters of the other sections 31 of the helical spring 30 remain.

Referring to FIG. 8, the bit 41 is deeper in the axial space 15. The second section of each of the balls 20 is placed in the annular groove 42 of the bit 41 in the axial space 15. The second section of each of the balls 20 is biased by the helical spring 30. Thus, the bit 41 is connected to the body 11 via the balls 20, which are biased by the helical spring 30.

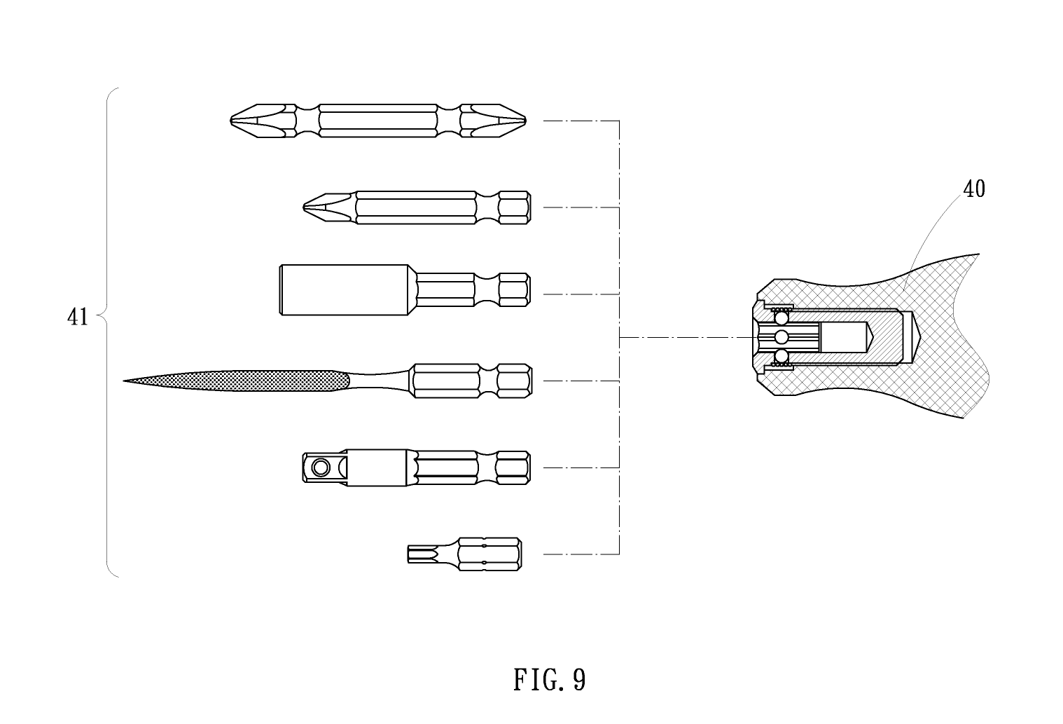

Referring to FIG. 9, there are shown various bits 41 that can be connected to the handle 40 by the chuck 10.

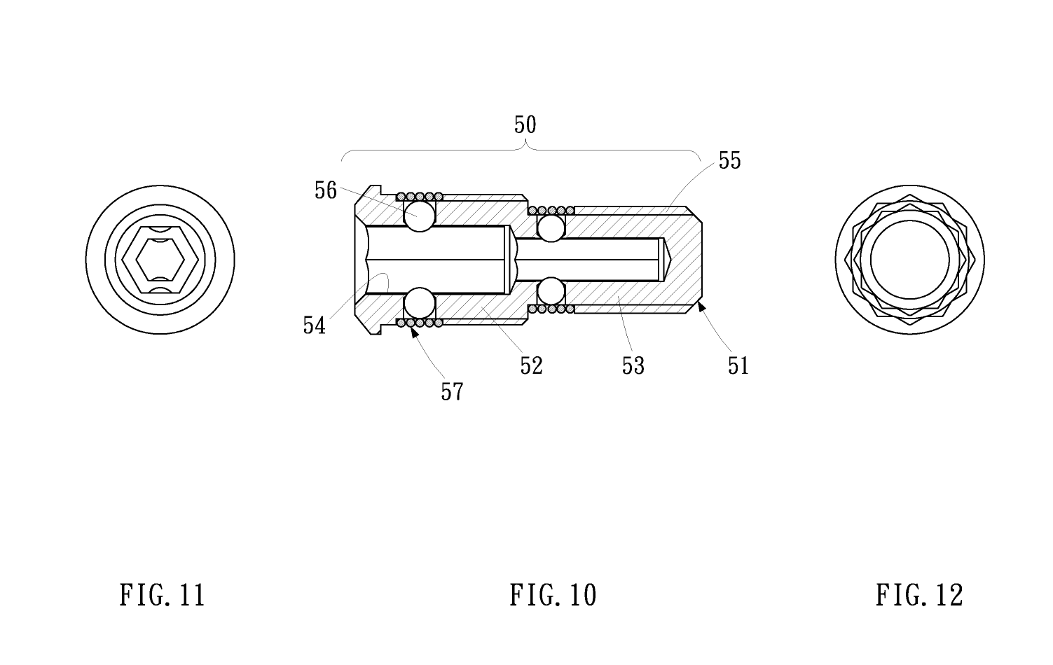

Referring to FIGS. 10 to 12, there is shown a chuck 50 according to a second embodiment of the present invention. Briefly speaking, the chuck 50 includes two chucks 10 directed identically but sized differently. The chuck 50 includes a body 51 formed with an annular flange 58 formed thereon, a large section 52 formed next to the annular flange 58, and a small section 53 formed next to the large section 52. Large balls 56 are placed in the large section 52 of the body 51 and a large helical spring 57 is placed around the large balls 56. Similarly, small balls 56 are placed in the small section 52 of the body 51 while a small helical spring 57 is placed around the small balls 56.

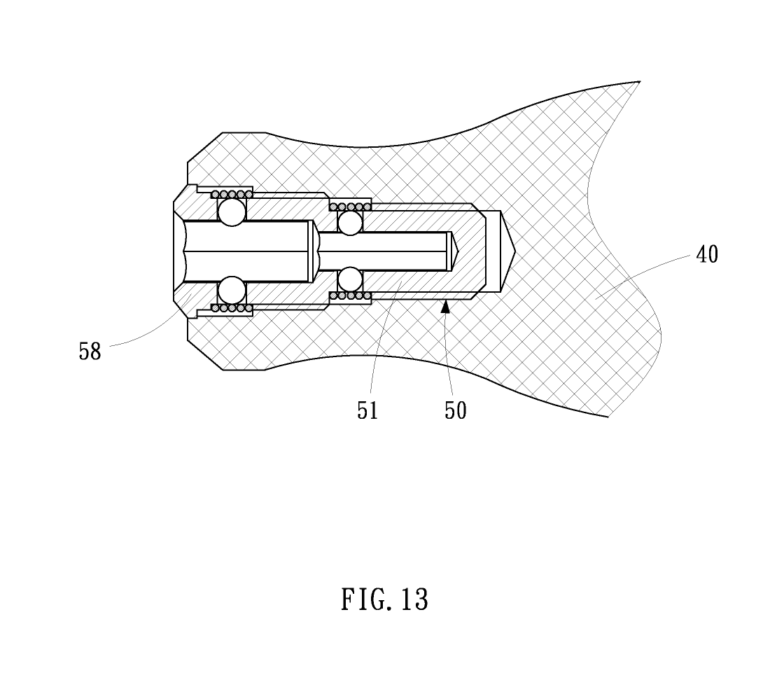

Referring to FIG. 13, the annular flange 58 is abutted against an end of a handle 40 while the large and small sections 52 and 53 of the body 51 are fit in the handle 40.

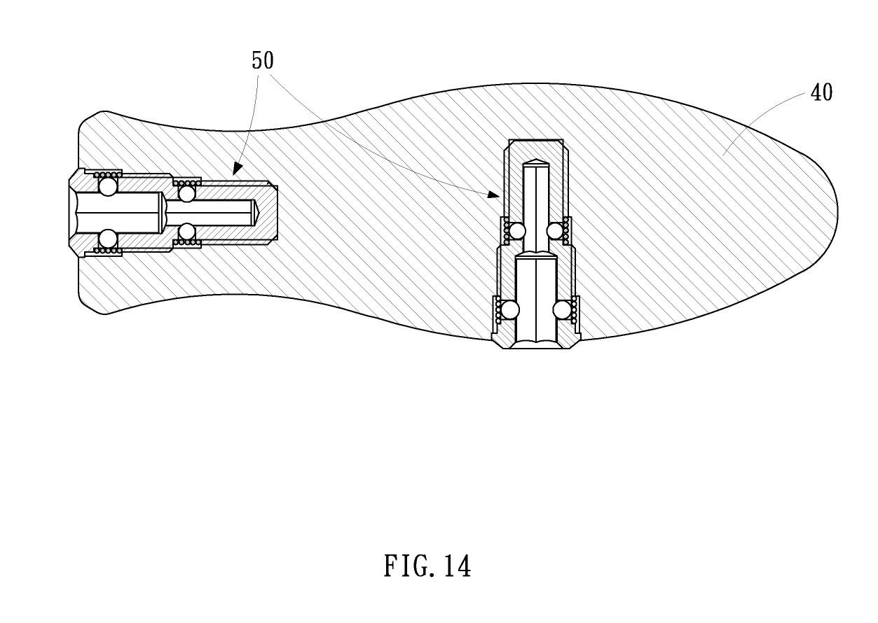

Referring to FIG. 14, a chuck 50 is axially inserted in the handle 40 while another chuck 50 is transversely inserted in the handle 40.

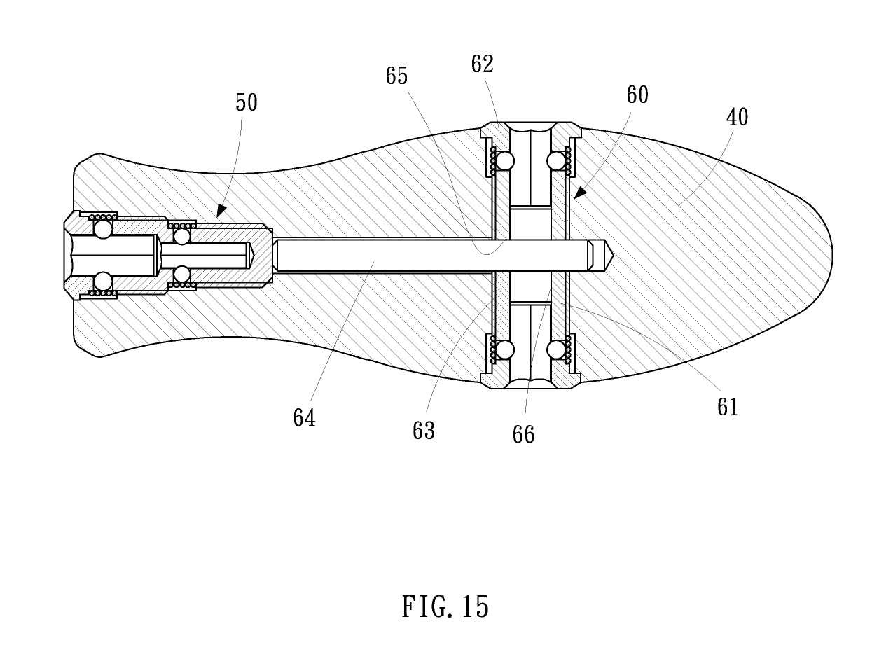

Referring to FIG. 15, the handle 40 is equipped with a chuck 50 and a chuck 60 according to a third embodiment of the present invention. The chuck 50 is axially inserted in while the chuck 60 is transversely inserted in the handle 40. Briefly speaking, the chuck 60 includes two chucks 10 sized identically but directed oppositely. The chuck 60 includes a body 61 including two annular flanges 62 each formed at a respective one of two opposite ends, a ribbed section 63 extending between the annular flanges 62, and bore 65 transversely defined in the ribbed section 63. A metal rod 64 is inserted in the handle 40. A section of the metal rod 64 is inserted in the bore 65. The metal rod 64 is used for reinforcement of the handle 40 when the handle 40 is operated to rotate the chuck 60 about the axis of the body 61.

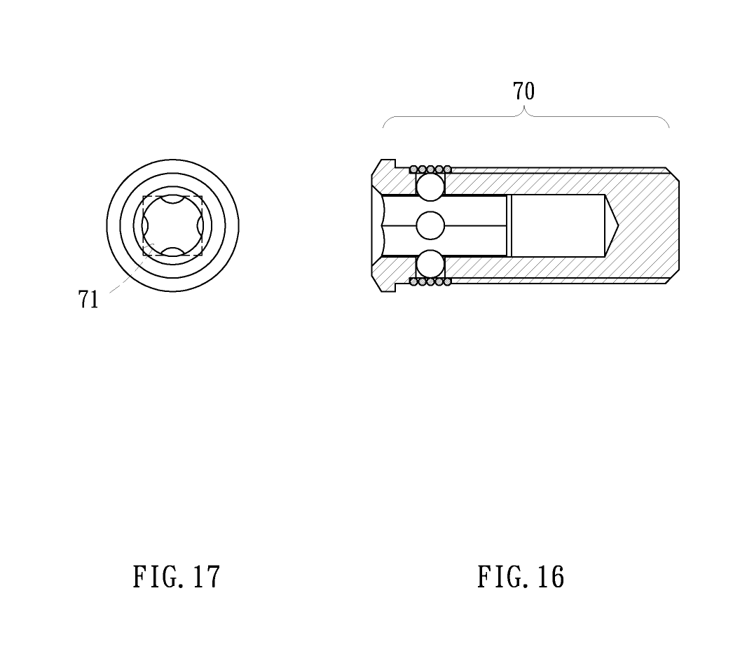

Referring to FIGS. 16 and 17, there is shown a chuck 70 according to a fourth embodiment of the present invention. The chuck 70 is identical to the chuck 10 except including a body 71 instead of the body 11. The body 71 is identical to the body 11 except that the axial space is square.

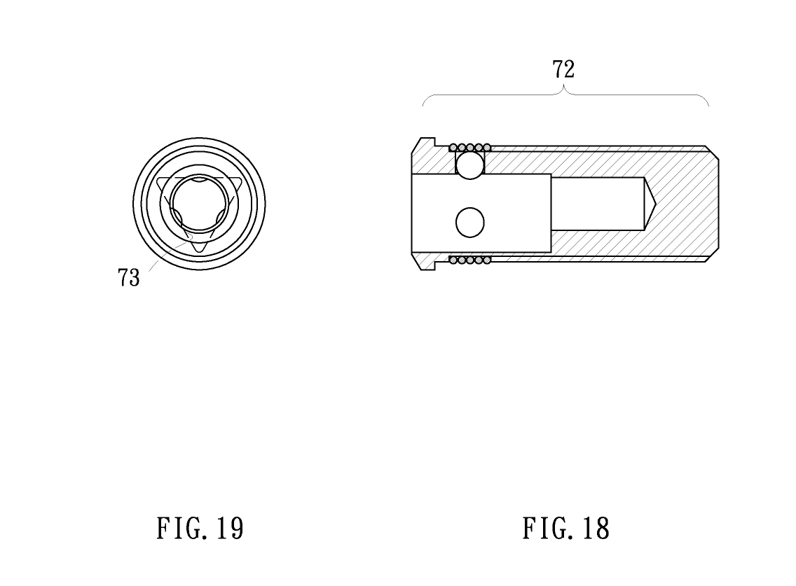

Referring to FIGS. 18 and 19, there is shown a chuck 72 according to a fifth embodiment of the present invention. The chuck 72 is identical to the chuck 10 except including a body 73 instead of the body 11. The body 73 is identical to the body 11 except that the axial space is triangular.

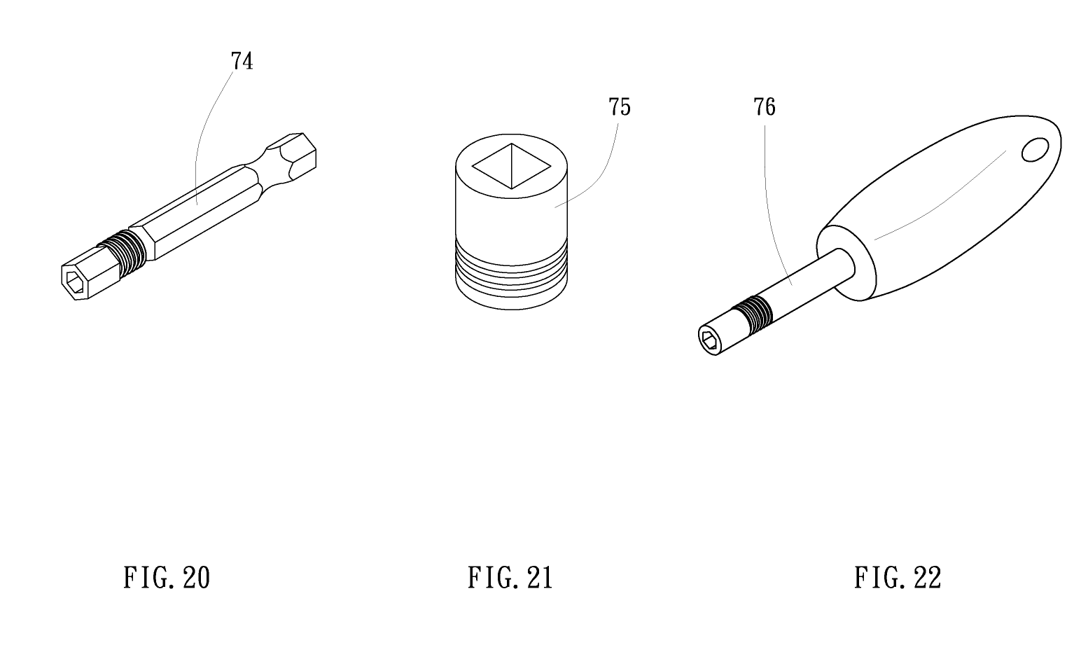

Referring to FIG. 20, there is shown a body 74 of a chuck according to a sixth embodiment of the present invention. The body 74 is in the form of an extensive rod for connecting a bit to a handle.

Referring to FIG. 21, there is shown a body 75 of a chuck according to a seventh embodiment of the present invention. The body 75 is in the form of a socket connecting a bit to a handle.

Referring to FIG. 22, there is shown a body 76 of a chuck according to an eighth embodiment of the present invention. The body 76 includes an end fit in a handle of a screwdriver for example.

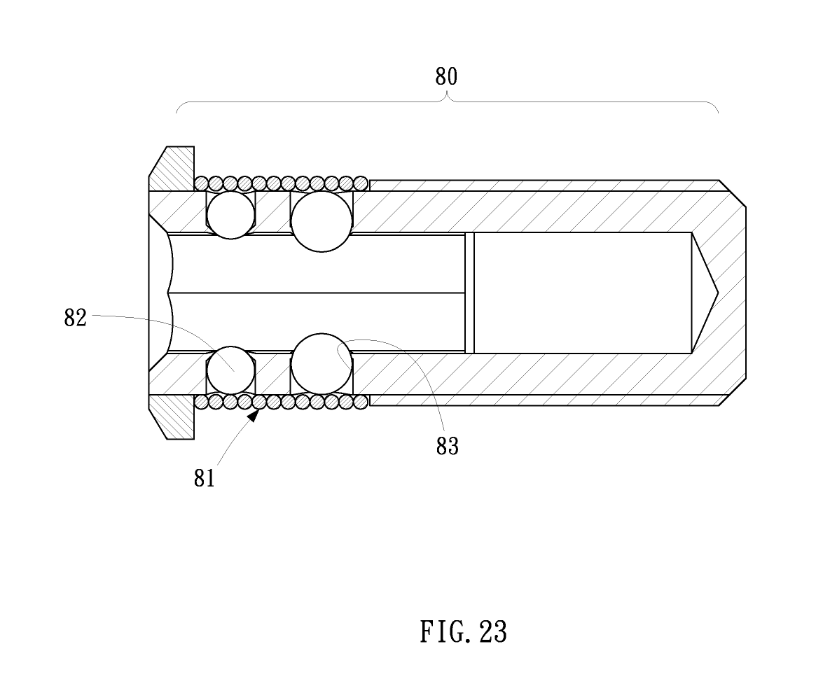

Referring to FIG. 23, there is shown a chuck 80 according to a ninth embodiment of the present invention. The chuck 80 is like the chuck 10 except including two groups of balls 82 substantially placed in two groups of bores 83 defined in the body. Each group of balls 82 and the respective group of bores 83 are identical to the balls 20 and the radial bores 16.

The present invention has been described via the detailed illustration of the embodiments. Those skilled in the art can derive variations from the embodiments without departing from the scope of the present invention. Therefore, the embodiments shall not limit the scope of the present invention defined in the claims.

1. A chuck including:
a body including an axial space defined therein and at least one radial bore with a small open end near the axial space and a large open end in an external side thereof;
at least one ball including a first section movably placed in the radial bore, a second section movable into the axial space, and a third section movably placed outside the radial bore; and
a helical spring placed around the body and in contact with the third section of the ball for biasing the second section of the ball into a recess defined in a bit inserted in the axial space.

2. The chuck according to claim 1, wherein the body includes an annular groove receiving the helical spring.

3. The chuck according to claim 2, wherein the body includes a ribbed section to be fit in a handle.

4. The chuck according to claim 1, wherein the axial space is hexagonal.

5. The chuck according to claim 1, wherein the axial space is square.

6. The chuck according to claim 1, wherein the axial space is triangular.

7. A chuck including:
a body including a front section, a rear section, an axial space defined in the first and second sections, at least one front radial bore defined in the front section, and at least one rear radial bore defined in the rear section, wherein each of the front and rear radial bores includes a small open end near the axial space and a large open end in an external side thereof with a small open end near the axial space and a large open end in an external side thereof;
at least one front ball including a first section movably placed in the front radial bore, a second section movable into the axial space, and a third section movably placed outside the front radial bore;
at least one rear ball including a first section movably placed in the rear radial bore, a second section movable into the axial space, and a third section movably placed outside the rear radial bore; and
at least one helical spring placed around the body and in contact with the third section of each of the front and rear balls for biasing the second section of each of the front and rear balls into a recess defined in a bit inserted in the axial space.

8. The chuck according to claim 7, wherein the front section of the body includes an external diameter identical to that of the second section.

9. The chuck according to claim 8, wherein the front ball includes a diameter identical to that of the rear ball.

10. The chuck according to claim 7, wherein the front section of the body includes an external diameter larger than that of the second section, wherein the chuck includes a front helical spring placed around the front section of the body and in contact with the front ball and a rear helical spring placed around the rear section of the body and in contact with the rear ball.

11. The chuck according to claim 10, wherein the front ball includes a diameter larger than that of the rear ball.

12. A tool including a handle, a first chuck axially fit in the handle, and a second chuck transversely fit in the handle, wherein each of the first and second chucks includes:
a body including an axial space defined therein and at least one radial bore with a small open end near the axial space and a large open end in an external side thereof;
at least one ball including a first section movably placed in the radial bore, a second section movable into the axial space, and a third section movably placed outside the radial bore; and
a helical spring placed around the body and in contact with the third section of the ball for biasing the second section of the ball into a recess defined in a bit inserted in the axial space.

13. The chuck according to claim 12, further including a rod axially placed in the handle for reinforcement, wherein the body includes a bore in which the rod is inserted.
